(19) United States
(12) Patent Application Publication
(10) Pub. No.: US 2007/0007219 A1
(43) Pub. Date: Jan. 11, 2007

(54) Method and device for fundraising

(76) Inventor: William J. Parker, Harrisburg, PA (US)

Correspondence Address: Baker & Daniels, Ste. 700, 805 15th Street, N.W., Washington, DC, 20005, US

(21) Appl. No.: 11/473,333

(22) Filed: Jun. 23, 2006

Related U.S. Application Data
(63) Continuation-in-part of application No. 11/431,098, filed on May 10, 2006.
(60) Provisional application No. 60/693,055, filed on Jun. 23, 2005.

(51) Int. Cl. B01D 61/00

(52) U.S. Cl. 210/767

(57) ABSTRACT

A multi-dimensional fundraising apparatus is provided for use in fundraising activities. The apparatus may include multiple faces and at least one cell on each of the multiple faces. The cells may be formed as interlocking puzzle pieces. Each cell may have a pre-designated donation level. A unique initial cell appearance may be provided for each cell having a unique donation level. Additionally, a method for fundraising may include implementing the multi-dimensional device having multiple cells, wherein each cell represents a corresponding donation value. The method may additionally include obtaining a fundraising commitment for a donation value corresponding to a cell and associating the fundraising commitment with the corresponding cell.

### CONTINUING DATA

This application claims priority from U.S. Provisional Application Ser. No. 60/693,055 and is a CIP of U.S. patent application Ser. No. 11/431,098

### BACKGROUND OF THE INVENTION

1. Field of the Invention

This invention relates to a device and method for fundraising.

2. Description of Prior Art

Fundraising is a term referring to the process of soliciting and gathering money by requesting donations from individuals, businesses, charitable foundations, or governmental agencies. Although fundraising typically refers to efforts to gather funds for not-for-profit organizations, it is occasionally used to refer to the identification and solicitation of investors or other sources of capital for for-profit enterprises.

Fundraising is the primary technique by which non-profit organizations obtain the money for their operations. These non-profit organizations can involve a broad array of philanthropic groups such as religious groups, research organizations, public broadcasters, political campaign groups, educational institutions, or other organizations. Some examples of objectives of such organizations may include the provision of student scholarship merit awards for athletic or academic achievement, addressing humanitarian concerns, providing disaster relief, supporting human rights, sponsoring research, or addressing social issues. When special events are arranged to raise funds, these events are often known as benefits, fund drives, pledge drives, or telethons.

Efforts of the above-identified organizations may be organized on a local, national, or global level. Funds raised through the events described above, may in some instances go towards providing for the basic needs of others, and at other times may go to furthering the goals of the organization. For instance, in the case of religious groups, while funds may be used to provide for the basic needs of others, the funds may also be used exclusively or in part for evangelism. In general, religious groups may mix these goals and dispute over the appropriate mix may create a tension within the organization and among its supporters.

In the United States, in the case of political campaigns, fundraising, despite numerous campaign finance reform laws, continues to be a highly controversial topic. Political action committees (PACs) are the most well known organizations that back candidates and political parties, though others, such as 527 groups may also have an impact.

While public broadcasters are completely government funded in some of the world, in other countries, funds for public broadcasting come from public donations. Pledge drives commonly occur about three times each year, usually lasting one to two weeks each time. Viewership and listenership often decline significantly during funding periods. Thus, special programming may be aired in order to keep regular viewers and listeners interested. An analogous “special programming” occurs in commercial television during sweeps.

In the United States, the Internal Revenue service has given fundraising organizations a specific designation of 501(c)(3). To qualify for this designation, a fundraising organization must outline a mission statement, which states its main purpose and objectives, and its overall policies. Large organizations typically will list their programs of involvement, types of funding received, and manner of allocating expenses. In addition, these organizations are rated annually for both efficiency and compliance by the American Institute of Philanthropy and other watchdog groups.

Many non-profit organizations receive some annual funding from a financial endowment, which is a large sum of money that is usually invested to generate a sizable amount of interest each year. Endowments are generally created when a sizable gift is received from an individual or family, often as directed in a will upon the death of a family member. Corporate entities also may contribute to endowments, which are often handled by charitable organizations known as foundations.

While fundraising often obtains money in the form of gifts, money may also be generated by selling a product. For example, Girl Scouts are well-known for selling cookies in order to generate funds.

Throughout recent history, various methods and devices have been used to compete for donor contributions and in fundraising efforts. Whether for charitable work in the nonprofit sector, political party and campaign causes, or private solicitation of funds, fundraising can often be a competitive business and specialization. Indeed, organizations seeking funds will often hire a fundraising specialist to assist with the solicitation of donations.

To aid in the solicitation of funds and donations, mechanisms or devices may be tied via a fundraising method or symbolically to the fundraising cause. These mechanisms or devices have been shown in the past to greatly aid in the solicitation of funds. As such, methods, mechanisms, and devices which aid and/or increase the amount of funds given in response to solicitation are valuable and desirable.

For example, in 1919, the National Society for Crippled Children was founded. After several decades of relatively unsuccessful fundraising campaigns, a new method and device were conceived and in the spring of 1934, the National Society for Crippled Children launched its first Easter “seals” campaign to raise money for its services. To show their support, donors placed the seals on envelopes and letters. The fundraising method utilizing the Easter seals proved to be a very successful technique. In fact, largely as a result of the method of fundraising (i.e. the Easter seal), the fundraising method soon gained wider recognition than the official name of the organization. The overwhelming public support for the Easter seals campaign triggered a nationwide expansion of the organization and a swell of grassroots efforts on behalf of people with disabilities. By 1967, the Easter seal was so well recognized, the organization formally adopted the name “Easter Seals”.

The marketing of Girl Scout cookies is another example of a fundraising tool that has become very successful in the solicitation of funds for an organization. In 1922, the Girl Scout magazine, The American Girl, suggested cookie sales as a fundraiser and provided recipes. In the 1920s and 1930s, the cookies were actually baked by the Girl Scouts and their families. By 1936, the utilization of cookie sales as a fundraising tool had become so successful that the national organization began licensing commercial bakers to produce them. Traditionally, Girl Scouts sell to their own relatives and visit neighborhood homes, taking orders for numbers of boxes of each cookie type desired by each house. They also note the total order cost of each customer on a paper chart. Parents may also sell to co-workers in the workplace. In recent years, due to safety concerns, the emphasis is shifting toward sales from tables in well-frequented public areas under the supervision of adult troop leaders. As an incentive to sell, Girl Scouts are offered prizes (stuffed animals, trinkets, coupons, etc.) of successively higher value as the number of boxes sold increases. The accumulation of prizes is cumulative, so that a girl who has won the prize for selling 100 boxes of cookies will still also receive a 75 box prize, a 50 box prize, a 25 box prize, a 20 box prize, a 15 box prize, and a 100 box prize.

The “walkathon” or sponsored walking event is another example of a fundraising method. It was first popularized and made successful with the March of Dimes WalkAmerica event. Participants walk as individuals or as part of a team. Walkers ask friends, family, business associates, and others to sponsor them by making a donation to the March of Dimes. Others volunteer their time to register walkers, staff checkpoints, and offer refreshments. As the March of Dimes biggest fund-raiser, WalkAmerica supports lifesaving research and innovative programs that save babies from prematurity, birth defects, and other health problems. Since its beginning in 1970, WalkAmerica has raised more than one billion dollars to help give babies a fighting chance. As further evidence of its success and as a fundraising technique, WalkAmerica takes place in all 50 states, the District of Columbia, and Puerto Rico. Most events are held at the end of April. More than nine million men, women, and children will participate as sponsors, volunteers, and walkers this year.

Recently, the use of symbolic wristbands and bracelets has been shown to be an effective device and method of fundraising. It started with Lance Armstrong, the American cyclist, who a number of years ago was diagnosed with a cancer so virulent that he was given only a forty percent chance of survival. He created the Lance Armstrong Foundation and designed the yellow Livestrong wristband: the yellow for the jersey of the Tour de France leader and “live strong” his motto. Five million bands were made, to be sold at $1 each, with all proceeds going to the LAF. After Armstrong won his sixth Tour de France, the bracelets sold out within days. Millions more were manufactured, but by the time celebrities such as Bruce Willis, Matt Damon, Robin Williams, and Bono started to back the campaign, new orders were flooding in at a rate of nearly 400,000 per day from the charity website. The craze caught on in Britain, but people here had to wait up to a month to receive their bracelets because of demand. As a result, a black market grew on the internet, with second hand wristbands selling for many times their cost, with none of the profit going to charity.

### SUMMARY OF THE INVENTION

Embodiments of the invention include a multi-dimensional fundraising apparatus for use in fundraising activities. The apparatus includes at least one cell on each of multiple faces. Each cell has a pre-designated donation level. Furthermore, each cell having a unique donation level may include a unique initial cell appearance.

In additional aspects, a fundraising method may be provided. The method may include implementing a multi-dimensional device having multiple cells. Each cell may represent a corresponding donation value. The method may additionally include obtaining a fundraising commitment for a donation value corresponding to a cell and associating the fundraising commitment with the corresponding cell.

In an additional aspect of the invention, a fundraising method is provided that includes implementing a multi-dimensional device having multiple cells. The method may additionally include assigning a donation level to each cell of the multi-dimensional device and determining an initial cell appearance for each cell, wherein each donation level corresponds to a unique initial cell appearance.

### BRIEF DESCRIPTION OF THE DRAWINGS

FIG. 1 is a representation of a two-dimensional embodiment or the device of a side of a three-dimensional embodiment of the device;

FIG. 2 is a representation of a two-dimensional embodiment of the device or of a side of a three-dimensional embodiment of the device;

FIG. 3 is a perspective view of a three-dimensional embodiment of the device;

FIG. 4 is a perspective view of a three-dimensional embodiment of the device;

FIG. 5 is a perspective view of a three-dimensional embodiment of the device;

FIG. 6 is a representation of a two-dimensional embodiment of the device or of a side of a three-dimensional embodiment of the device;

FIG. 7 is a representation of a two-dimensional embodiment of the device or of a side of a three-dimensional embodiment of the device;

FIG. 8 is a representation of a two-dimensional embodiment of the device or of a side of a three-dimensional embodiment of the device;

FIG. 9 is a flow chart illustrating a method in accordance with an embodiment of the invention;

FIG. 10 is a representation of a two dimensional embodiment of the device or a side of a three dimensional embodiment of the device;

FIG. 11 is a representation of a two dimensional embodiment of the device or a side of a three dimensional embodiment of the device; and

FIG. 12 is a representation of a two dimensional embodiment of the device or a side of a three dimensional embodiment of the device.

### DETAILED DESCRIPTION OF THE EMBODIMENTS OF THE INVENTION

The embodiments of the invention described herein provide for a method and apparatus for fundraising implementing a multi-dimensional device.

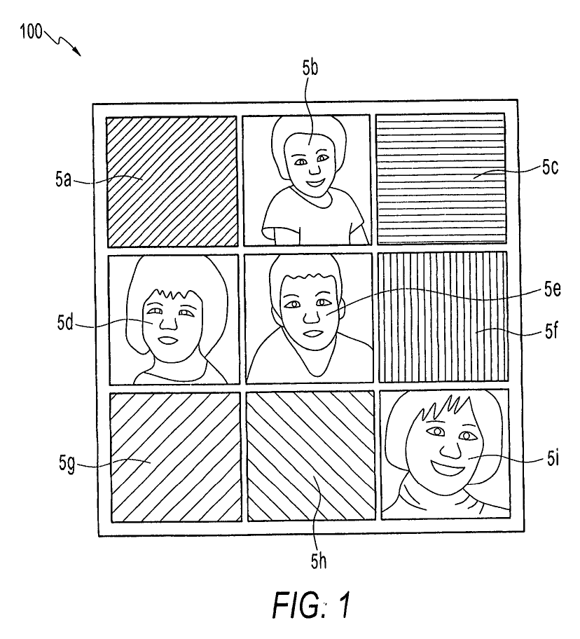

As illustrated in FIG. 1, a planar face 100 of the device may be divided into subdivisions or cells. A device may include one or more planar faces. The sub-divisions or cells of the device can comprise different colors, images, graphics, patterns, numbers, letters, and/or symbols. The planar face 100 illustrated in FIG. 1 may have a square shape as illustrated or may alternatively have other shapes as explained below. The square face 100 is divided into nine separate cells 5a-i. Cells 5a, 5c, 5f, 5g, and 5h comprise different solid colors. Cells 5b, 5d, 5c, and 5i exemplify cells with an image within the cell. In this example, cells 5b, 5d, 5e, and 5i are images of children corresponding to donations or fundraising pledges.

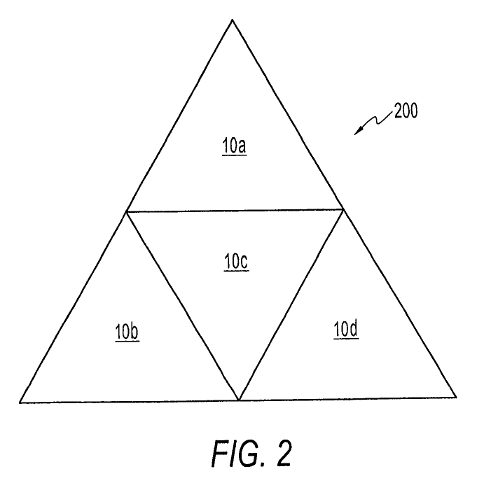

As illustrated in FIG. 2, a planar face 200 may be triangular in shape. The planar face 200 may be divided into triangular cells 10a, 10b, 10c, and 10d.

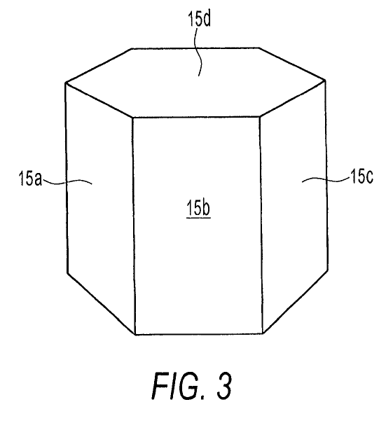

As illustrated in FIG. 3, a multi-dimensional device 300 can be a three dimensional object. The three-dimensional object and shapes can be multi-faceted and multi-sided. For example, the three-dimensional object and shape may be a multi-sided geometric solid. Each side of the multi sided three dimensional solid can comprise different colors, images, graphics, patterns, numbers, letters, and/or symbols. As shown in FIG. 3, the multi-sided geometric solid 300 may have multiple faces. The faces 15a, 15b, and 15c may be rectangular and may include images, such as images of children corresponding to donations or fundraising pledges. Three opposite sides, not shown in this figure, may also be rectangular. A top side or face 15d may be hexagonal and may serve the same function. Similarly, in this example, a bottom side would also be hexagonal.

In a preferred embodiment, the multi-dimensional device is a platonic solid. For example, the multi-dimensional device can comprise a tetrahedron, cube, octahedron, dodecahedron, or icosahedron. Each side of the multi-dimensional device can comprise different colors, images, graphics, patterns, numbers, letters, and/or symbols. Each side can also comprise numbers or symbols that connote a dollar amount. In a further embodiment, each side may be divided into sub-divisions or cells. These sub-divisions or cells can comprise independently different or same colors, images, graphics, patterns, numbers, letters, and/or symbols. The sub-division or cell can also comprise numbers or symbols that connote a dollar amount. In yet further embodiments, the sub-divisions or cells can comprise puzzle pieces (i.e., interlocking irregular cut pieces or shapes that can be fitted together to form the shape). “Cell”, as used herein, is understood to include and comprise “puzzle piece.”

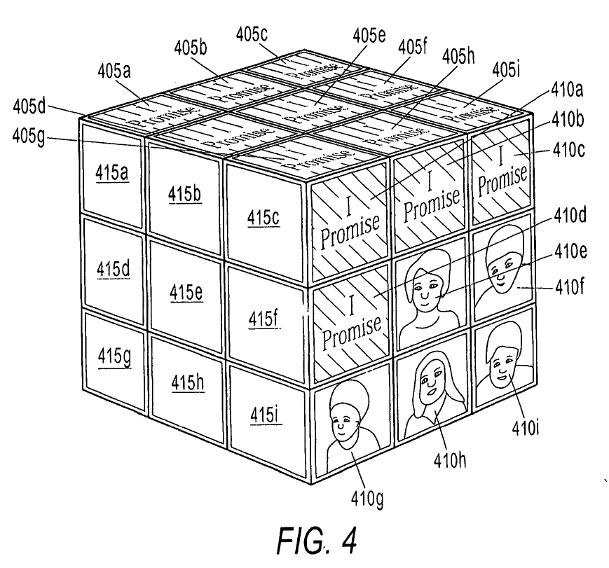

FIG. 4 illustrates an embodiment of a three-dimensional object comprising a cube 400. In this perspective drawing of the cube 400, three sides 405, 410, and 415 can be seen. Each of the sides 405, 410, and 415 may be divided into sub-divisions or cells. Side 405 is divided into none cells, 405a-i. In this example, cells 405a-i each comprise the same color and the same letters. For example, each cell 405a-i may comprise the color white with red letters spelling “IPromise”. Side 415 may also be divided into nine cells 415a-i. In this example, some cells 415a-i may all comprise the same color, such as green, and may be without any symbols or lettering. Side 410 may also be divided into nine cells 410a-i. Cells 410a-d may comprise a yellow color background with the white letters in the foreground spelling “IPromise”. Cells 410e-i may be images of children. In this particular example, the images of children in cells 410e-i correspond to donations and/or fundraising pledges for a child.

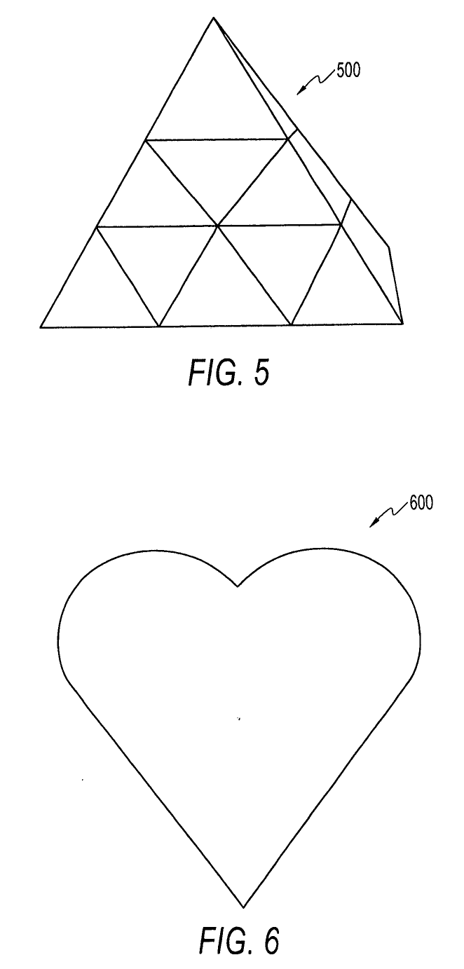

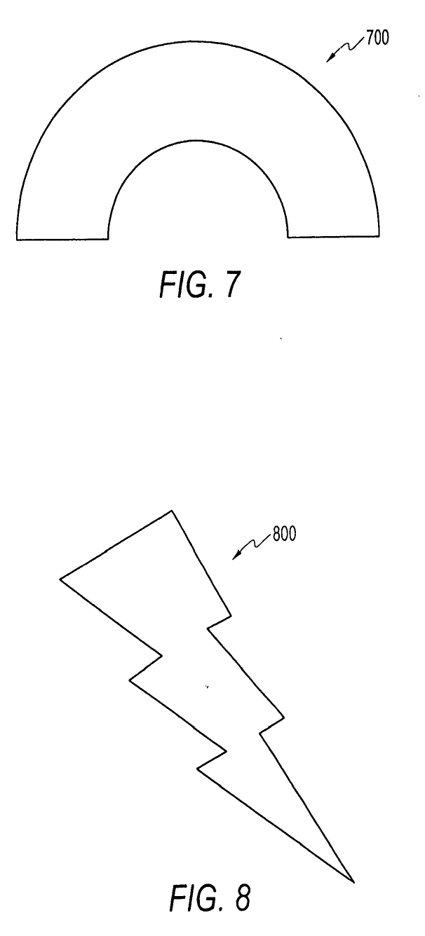

FIGS. 5-8 illustrate various shapes that the three dimensional device or two dimensional faces of the three-dimensional device may assume or include. For example, FIG. 5 illustrates a three dimensional pyramid type structure 500 divided into triangular faces, each triangular face having cells, which may also be triangular. FIG. 6 depicts an embodiment of a two dimensional object 600 having a heart shape. This two dimensional object 600 may be a face of a larger three-dimensional device and may be divided into cells assuming any selected shape. FIG. 7 depicts a two dimensional face 700 of a three dimensional object. The two-dimensional face 700 has a rainbow shape and may be divided into smaller cells or subdivisions if desired. FIG. 8 illustrates a two dimensional face 800 of a three-dimensional object in the shape of a lighting bolt. Both the two dimensional faces and three dimensional objects may include any appropriate shape. The two-dimensional shapes may for instance be ribbon shapes or candle shapes. The two-dimensional shapes may also comprise regular polygons (i.e., many-sided geometric figures with equal length sides and equal angles). For example, the two dimensional objects and shapes may comprise a triangle, square, pentagon, hexagon, heptagon, octagon, etc. The three-dimensional shapes may also comprise any geometric solid or representation of a geometric solid. In a preferred embodiment, the three dimensional shapes comprise platonic solids. For example, the three dimensional shapes may comprise a tetrahedron, cube, octahedron, dodecahedron, or icosahedron.

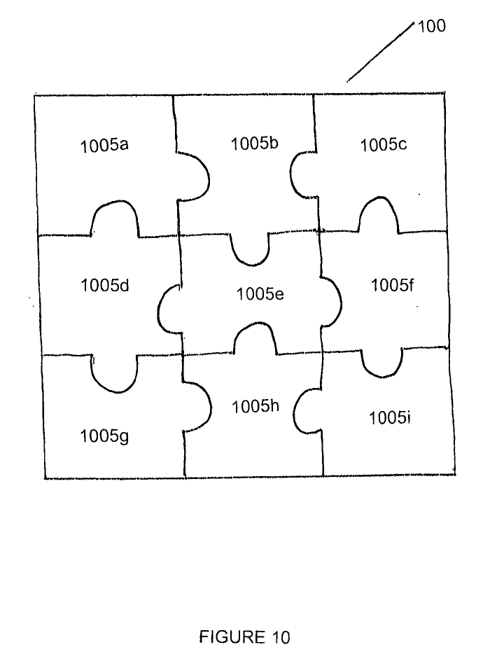

FIGS. 10-12 illustrate embodiments of a two-dimensional object that is divided into sub-divisions or cells comprising puzzle pieces. As shown in FIG. 10, the two-dimensional object comprises a square face 1000. The square face 1000 is divided into nine separate cells 1005a-i. In a further embodiment, the cells comprise colors, patterns of colors, graphics, numbers, characters, images, or a combination thereof.

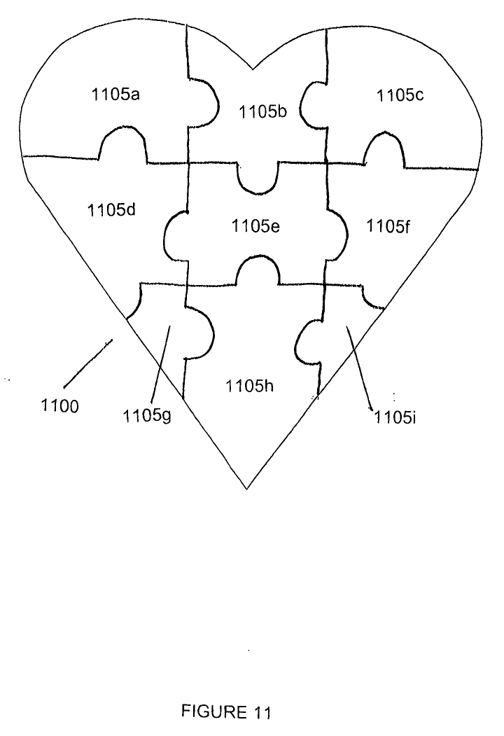

In another example, FIG. 11 shows an embodiment of a two-dimensional object that is divided into sub-divisions or cells comprising puzzle pieces. As shown in FIG. 11, the two-dimensional object comprises a heart-shaped face 1100. The heart-shaped face 1100 is divided into nine separate cells 1105a-i. In a further embodiment, the cells comprise colors, patterns of colors, graphics, numbers, characters, images, or a combination thereof.

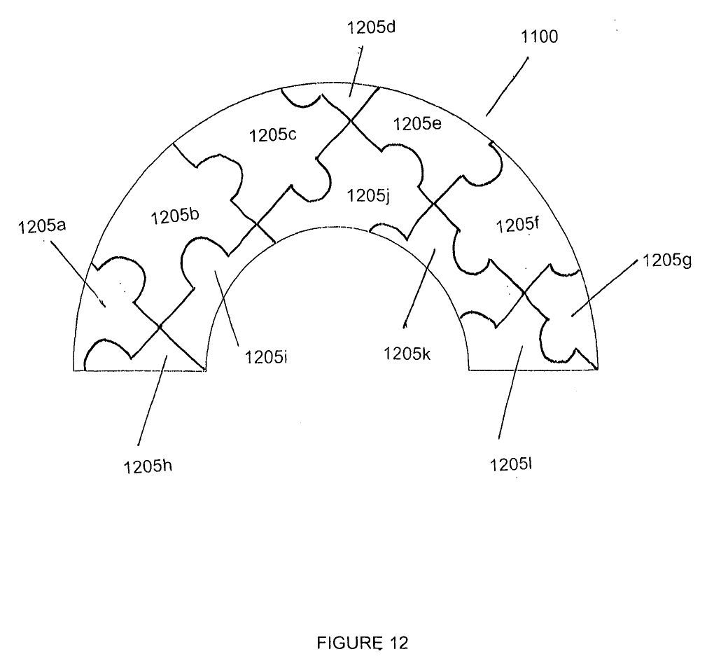

In another example, FIG. 12 shows an embodiment of a two-dimensional object that is divided into sub-divisions or cells comprising puzzle pieces. As shown in FIG. 12, the two-dimensional object comprises an arch-shaped face 1200. The arch-shaped face 1200 is divided into twelve separate cells 1205a-l. In a further embodiment, the cells comprise colors, patterns of colors, graphic, numbers, characters, images, or a combination thereof.

The multi-dimensional device as shown in FIGS. 1-8 and 10-12 may be made from any suitable material. For example, any material appropriate for forming two-dimensional or three dimensional structures may be utilized. In one preferred embodiment, the device may comprise paper and cardboard. For example, as shown in FIG. 4, each side of the cube may comprise a piece of cardboard. These pieces of cardboard may then be covered with cells comprising paper to form the cells of each side of the cube. In another preferred embodiment, the device may comprise paper, plastic, and metal. In a further preferred embodiment, the two-dimensional object or shape, or side of the three-dimensional device comprises a multi-piece jigsaw puzzle. In a further preferred embodiment, the three dimensional device comprises a modified Rubik's Cube™ puzzle game.

The multi-dimensional device may also be the electronic representation of a multi-dimensional device. For example, the two dimensional or three-dimensional structure may be presented and represented on electronic media such as a television of computer screen.

The multi-dimensional device may be of any size and dimension. For example, the multi-dimensional device may comprise a size conducive to holding in one's hand (i.e., several inches by several inches in dimensions) In another example, the multi-dimensional device may comprise a size conducive to presentation and viewing in a large audience room (i.e. several feet by several feet; or even several tens of feet by several tens of feet.)

When utilized in fundraising, the different sides and cells of the multi-dimensional device may correspond to different dollar amounts. These dollar amounts can be for money actually raised or donated. The dollar amounts can also represent amounts pledged or promised for donation. These pledged and/or promised dollar amounts may also represent amounts pledged within a single time period or pledged over multiple future time periods.

In the embodiment illustrated in FIG. 10, in which the cells comprise puzzle pieces, the cells 1005a-i can be worth equal dollar amounts. For example, cells 1005a-i may each be worth $250. Thus, when donations for all four of the cells have been found and associated with the cells on side 1000, each of the cells 1005a-i represents a donation or pledge of $250. In this example, the side 1000 symbolizes and represents combined donation amounts of $1,000. In this example, a pledge or donation of $250 corresponding to one of the cells 1005a-i could be a one-time donation or pledge. Alternatively, the pledge or donation of $250 could be a cumulative amount of a series of donations promised over multiple time periods. For example, a donor could promise to donate $50 a year for the next five years. In this example, the $250 corresponding to one of the cells 1005a-i would represent the cumulative amount of all the $50 pledged donations over the five years.

For example, in FIG. 2, the cells 10a-10d may be worth equal dollar amounts, for example $250. Thus when donations for all four of the cells have been found and associated with the cells on side 200, each of the cells 10a-d represents a donation or pledge of $250. In this example, the side 200 symbolizes and represents combined donation amounts of $1000. A pledge or donation of $250 corresponding to one of cells 10a-d could be a one-time donation or pledge. Alternatively, the pledge or donation of $250 could be a cumulative amount of a series of donations promised over multiple time periods. For example, a donor could promise to donate $50 a year for the next five years. In this example, the $250 corresponding to one of cells 10a-10d would represent the cumulative amount of all the $40 pledged donations over the five years.

In another embodiment, shown in FIG. 10, in which the cells comprise puzzle pieces, the cells 1005a-i can be differing dollar amounts. For example, cell 1005a could represent $50, cell 1005b could represent $250, cell 1005c could represent $1000, and cell 1005d could represent $5000. As described above, these dollar amounts could be a one-time donation or pledge. Alternatively, these dollar amounts could be a cumulative amount of a series of donations promised over multiple time periods. For example, cell 1005c representing $1000 could represent the cumulative dollar amount resulting from a pledge of $250 per year for the next five years.

The cells on a side may also represent differing or increasing dollar amounts. The dollar amount that the cell represents may be disclosed on the cell itself with numbers, letters, or other characters or symbols. In this embodiment, as shown in FIG. 2, the cells 10a-10d could represent differing dollar amounts. For example, cell 10b could represent $50, cell 10c could represent $250, cell 10d could represent $1000, and cell 10a could represent $5000. As described above, these dollar amounts could be a one-time donation or pledge. Alternatively, these dollar amounts could be cumulative amount of a series of donations promised over multiple time periods. For example, cell 10d representing $1000 could represent the cumulative dollar amount resulting from a pledge of $250 per year for the next five years.

Considering a three-dimensional object as a whole, the different sides of a multi-sided geometric shape can represent equal dollar amounts or each side can represent different dollar amounts. For example, in FIG. 4, sides 405, 410, and 415 can each represent the same dollar amount. In another embodiment, shown in FIG. 4, sides 405, 410, and 415 can each represent different dollar amounts. In a further embodiment of the three dimensional object, each cell of a side can represent equal dollar amounts or different dollar amounts. For example, in FIG. 4, each of the cells on side 415 could represent $250. Each of the cells on side 410 could represent $500. Each of the cells on side 405 could each represent $1000. Accordingly, in this embodiment, each of the cells of side 415 would represent a combined dollar amount of $2250. Each of the cells on side 410 would represent a combined dollar amount of $4500. Each of the cells on side 405 would represent a combined dollar amount of $9000. Alternatively, in another embodiment, each of the cells on sides 405, 410, and 415 could represent differing dollar amounts. In a further embodiment, the cells of side 405 could represent differing dollar amounts as compared to the other cells on side 405. However, some or all of the dollar amounts of the cells of side 405 could represent the same dollar amounts as compared to the other sides of the cube 400 or to the cells of the other sides of the cube 400. In a further example of this embodiment, the cells of sides 405, 410, and 415 can comprise puzzle pieces. As discussed above with relation to other embodiments, the dollar amounts in the three-dimensional embodiment can represent pledged and/or promised dollar amounts for amounts pledged within a single time period or pledged over multiple future time periods.

When utilized in fundraising, the different sides and cells of the multi-dimensional device may be changed, revised, and/or updated to reflect current donation levels and pledge amounts. For example, when a donation corresponding to a dollar amount represented by a selected side or cell of a multi-dimensional device is received or pledged, that selected side or cell could be revised or updated. In a preferred embodiment, a side or cell of a multi-dimensional device may be blank or of a single color or pattern at the initial outset of a fundraising campaign. When a donation or pledge is received, a side or cell of the multi-dimensional device is changed from its condition at the initial outset to a new revised and changed designation. For example, in a preferred embodiment, a cell of a side of the multi-dimensional device is of a single solid color at the initial outset of a fundraising campaign. The solid color represents and corresponds to a dollar amount sought in the fundraising campaign. When that dollar amount is donated or pledged, the solid color for the cell is revised to a different color or image. For example, the cell could be changed from a solid color to an image of a child. In a further preferred embodiment, the child in the image is an actual child who will be benefited by the fundraising and/or donation or pledge.

The changing or revision of a side and/or cell of the multi-dimensional device may be made by any suitable means and with any suitable material. For example, in the case of a handheld sized multi-dimensional device, a revised cell or side may be affixed or pasted to the initial cell or side. Alternatively, the initial cell or side may be removed and a revised cell or side may be substituted for the initial cell or side. For example, when a donation or pledge is received corresponding to a dollar amount of a selected cell on a multi-dimensional device, the selected cell can be revised from an initial solid color to an image of a child. The image of the child can be affixed or pasted over the top of the initial solid color material. Alternatively, the initial solid color material can be removed and the image of the child can be substituted.

In the case of an electronic representation of the multi-dimensional device, the individual sides and cells of the multi-dimensional device can be electronically manipulated to change and/or revise the sides and cells of the electronic representation of the multi-dimensional device.

The device described above may be utilized in a method of fundraising and/or soliciting funds. In a preferred embodiment of a method for utilizing the device for fundraising, donations, or pledges of donations are acquired corresponding to each of the sides or cells of the device. In this manner, the device can serve as a status indicator of the number or donations successfully received and the number of donations remaining to be sought. The device also serves as a representation of the fundraising campaign.

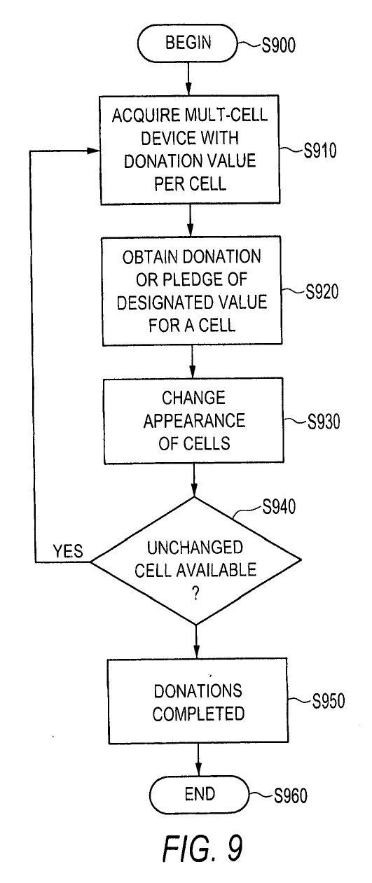

FIG. 9 illustrates a method in accordance with an embodiment of the invention. The method begins in step 900 and in step S910, a fundraising entity or individual acquires an embodiment of the above-described multi-dimensional device having a donation value for each cell. In S910, the fundraising individual or entity obtains a donation or pledge of the designated value for a cell. In S930, the appearance of the cell having the designated value for which a donation has been provided changes. The appearance may change in any manner such as those specified herein. In S940, if no unchanged cell is available, the donations are completed in S950. If unchanged cells are available, the fundraiser seeks to obtain donations for the unchanged cells by returning to S920. The process ends in S960.

Thus, in a preferred embodiment, at the outset of the fundraising campaign, campaign fundraising personnel are provided with the multi-dimensional device. For example, the multi-dimensional device may be a cube with nine cells on each side of the cube. Accordingly, in the following examples, a cube is described and utilized. However, it will be recognized by one of skill in the art that the invention is not limited to the use of a cube. Rather, any multi-dimensional device as previously described and disclosed may be utilized with the methods, systems and processes disclosed herein.

At the outset of the fundraising campaign, each side of the cube is different color than the other sides of the cube. Each cell on a given side is of the same color. Each side of the cube corresponds to a different donation level. For instance, by way of nonlimiting example, at the outset of a fundraising campaign, the six-sided cube has a green side, an orange side, a yellow side, a purple side, a white side, and a red side. Each of the cells on a given side is of the same color (i.e. on the green side, all of the cells are green). Each of the sides of the cube corresponds to a different donation level solicited by the fundraising campaign. For example, the green side corresponds to a $5000 donation level, the orange side corresponds to a $2500 donation level, the yellow side corresponds to a $1000 donation level, the purple side corresponds to a $500 donation level, the white sides corresponds to a $250 donation level and the red side corresponds to a $100 donation level. Each of the nine cells on each side of the cube then represents a donation or pledge at the donation level corresponding to the side of the cube.

As noted above, a donation or pledge corresponding to a cell on the cube can be a one-time donation or pledge. For example, a pledge or donation corresponding to a yellow cell may indicate that a donor has pledged a one-time donation of $1000. Alternatively, the donation or pledge corresponding to a cell on the cube can be a cumulative amount of a series of donations promised over multiple time periods. In other words, if the fundraising campaign is raising funds for a five-year period of time, a donation or pledge corresponding to a yellow cell indicates that a donor has pledged $250 per year for the next five years for a total donated sum of $1000. In a further alternative embodiment, the donation or pledge corresponding to a cell can be an immediate donation or pledge of the dollar amount corresponding to that cell combined with subsequent donations over multiple time periods. Thus, if the fundraising campaign is raising funds for a five year time period, a donation or pledge corresponding to a yellow cell indicates that a donor has pledged $1000 for that year and promised to give $1000 each year for four subsequent years.

When a donation is secured for a given donation level, a cell on the side of the cube corresponding to the donation level can be changed to represent the donation. This change can be any revision or denotation changing the cell from the initial representation. For example, when a donation is secured for the $1000 donation level, a cell on the yellow side of the cube may be changed to reflect the acquisition of that donation. Accordingly, the initial yellow color of the cell may be replaced with a graphic denoting that a donation of $1,000 has been obtained.

In a further preferred embodiment, the graphic is selected by the donor. For example, the donor may choose to honor a child benefited by the fundraising campaign with the donation. To notate this significance, the donor may choose a photo stamp of that child and affix the stamp to an appropriate donation level cell on the cube. As further donations are acquired, the cells on the cube are changed on the sides corresponding to the appropriate donation level. In this manner, the cube becomes a gauge of the status of the efforts toward acquiring donations. In a further preferred embodiment, the donor is able to provide an image of the child. For example, a donor may upload an image of a child via the internet or send the image as an email attachment. The recipient of the image can then create a photo stamp to form the image for affixing to the cube.

In a further preferred embodiment, the receipt received by the donor also carries a photo stamp of the child that the donor wishes to honor. In another embodiment, the donor receives a thank you letter as a follow up to the donation. In a further embodiment, the donor receives a cube as a token of appreciation for the donation. If the donation comprises an ongoing pledge for subsequent donations in future years, the donor may receive research updates when donations for future years are received. These research updates can comprise information regarding research made possible by the fundraising campaign. In a further embodiment, the donor can receive updates regarding the child the donor has honored with a donation. For example, the donor can receive updates in future years on what the selected child has accomplished in the past year.

An aspect of the method of fundraising utilizing the device is the filling up of the device. As discussed previously, when a donation is received, a change is made to the cell corresponding to that donation. When donations have been received for each of the cells on the device, then each of the cells will have been changed to designate the donations. When all the cells have been changed from their initial representation, the device has been “filled up”.

In an embodiment of this method of fundraising, an aspect of the method for the fundraising campaign personnel to “fill up” the device or devices assigned to them. In a further embodiment, recognition and/or compensation is provided to fundraising campaign personnel that have filled up” the device or devices assigned to them. For example, fundraising campaign personnel who “fill up” their devices can have their names published and recognized in a communication circulated by the fundraising campaign.

Although the present invention has been described in terms of particularly preferred embodiments,. it is not limited to these embodiments. Alternative embodiments and modification which would still be encompassed by the invention may be made by those skilled in the art, particularly in light of the foregoing teachings. For example, the device is described in many of the embodiments and examples as a cube. However, the present invention is not intended to be limited to a cube, and can comprise any multi-dimensional structure, including a triangle, square, pentagon, hexagon, heptagon, octagon, tetrahedron, octahedron, dodecahedron, or icosahedron. Accordingly, this invention is intended to cover any alternative embodiments, modifications or equivalents which may be within the spirit and scope of the invention.

What is claimed is::

1. A multi-dimensional fundraising apparatus for use in fundraising activities, the apparatus comprising:
multiple faces;
at least one cell on each of the multiple faces, each cell having a pre-designated donation level;
a unique initial cell appearance for each cell having a unique donation level; and
a total donation value for the fundraising apparatus equal to a sum of the pre-designated donation value for each cell.

2. The multidimensional fundraising apparatus of claim 1, further comprising multiple cells on each face.

3. The multidimensional fundraising apparatus of claim 2, wherein the pre-designated donation level is an identical level for each cell on a selected face.

4. The multidimensional fundraising apparatus of claim 2, wherein the pre-designated donation level comprises different values for multiple cells on a selected face.

5. The multidimensional fundraising apparatus of claim 1, wherein each cell comprises a puzzle piece.

6. The multidimensional fundraising apparatus of claim 1, wherein a color of each cell designates the pre-designated donation level.

7. The multi-dimensional device of claim 1, further comprising a mechanism for changing the cell initial appearance upon reaching the pre-designated donation level for a corresponding cell.

8. The multidimensional fundraising apparatus of claim 7, wherein the mechanism for changing the initial cell appearance comprises means for changing a cell color.

9. The multidimensional fundraising apparatus of claim 7, wherein the mechanism for changing the initial cell appearance comprises means for adding a symbol to the cell.

10. The multidimensional fundraising apparatus of claim 7, wherein the mechanism for changing the initial cell appearance comprises means for incorporating an image into the cell.

11. The multidimensional fundraising apparatus of claim 7, wherein the mechanism for changing the initial cell appearance comprises electronic means.

12. The multidimensional fundraising apparatus of claim 7, wherein the mechanism for changing the initial cell appearance comprises a stamp for affixing to the initial cell.

13. The multi-dimensional fundraising apparatus of claim 1, wherein the apparatus comprises a Platonic solid.

14. The multi-dimensional fundraising apparatus of claim 13, wherein the apparatus comprises a cube.

15. The multi-dimensional fundraising apparatus of claim 14, wherein the cube comprises six sides, each of the six sides divided into nine cells.

16. A method for fundraising comprising:
implementing a multi-dimensional device having multiple cells, each of the multiple cells formed an interlocking a puzzle piece, wherein each cell represents a corresponding donation value;
obtaining a fundraising commitment for a donation value corresponding to a cell; and
associating the fundraising commitment with the corresponding cell.

17. The fundraising method of claim 16, further comprising changing an initial appearance of the corresponding cell to indicate that the donation value has been achieved.

18. The fundraising method of claim 17, further comprising obtaining a subsequent donation value corresponding to each cell and changing the initial appearance of each cell.

19. The method of claim 17, wherein changing an initial appearance comprises changing a cell color.

20. The method of claim 17, wherein changing an initial appearance comprises adding a symbol to the cell.

21. The method of claim 17, wherein changing an initial appearance comprises adding an image to the cell.

22. The method of claim 17, wherein changing an initial appearance comprises affixing a stamp to the cell.

23. The method of claim 16, further comprising providing multiple cells on each face of the device.

24. The method of claim 23, further comprising assigning an identical donation level to each cell on a selected face.

25. The method of claim 24, further comprising assigning different donation values for multiple cells on a selected face.

26. The method of claim 16, further comprising providing an initial cell color corresponding to a pre-designated donation level.

26. A method for fundraising comprising:
implementing a multi-dimensional device having multiple cells, each of the multiple cells formed as an interlocking puzzle piece;
assigning a donation level to each cell of the multi-dimensional device; and
determining an initial cell appearance for each cell, wherein each donation level corresponds to a unique initial cell appearance.

27. The fundraising method of claim 26, further comprising providing a mechanism for changing an appearance of a selected cell upon receiving a donation corresponding to the selected cell.

28. The fundraising method of claim 27, further comprising providing a stamp for affixing to the initial cell to change the cell appearance.

29. The fundraising method of claim 26, further comprising providing a multi-dimensional Platonic solid.

30. The fundraising method of claim 26, further comprising providing a cube.

31. The fundraising method of claim 30, further comprising dividing each of the six sides of the cube into nine cells.
